(19) United States
(12) Patent Application Publication
(10) Pub. No.: US 2003/0064845 A1
(43) Pub. Date: Apr. 3, 2003

(54) Silent chain transmission mechanism

(76) Inventor: Toyonaga Saito, Osaka (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/196,863

(22) Filed: Jul. 17, 2002

(30) Foreign Application Priority Data
Jul. 24, 2001 (JP) 223272/2001

(51) Int. Cl. F16G 13/04

(52) U.S. Cl. 474/212; 474/213

(57) ABSTRACT

A silent chain transmission mechanism comprises a silent chain, for example, a valve timing chain, composed of link rows connected to one another by connecting pins, each link row consisting of toothed link plates selected at random and arranged in parallel, side-by-side, relationship to one another, the link plates of each link row being interleaved with link plates of two adjacent link rows, and a sprocket in mesh with the chain, the sprocket having teeth cut with a hob cutter having a hob pitch smaller than the pitch of the chain. By combining the valve silent chain with the sprocket a low noise and low vibration silent chain transmission mechanism can be realized.

### BACKGROUND OF THE INVENTION

This invention relates to a silent chain transmission mechanism for transmitting power between sprockets having different numbers of teeth, and more specifically to a silent chain transmission mechanism, suitable for applications such as driving a camshaft and a balancer shaft from the crankshaft of a four-cycle engine.

A silent chain transmission mechanism, used when an intake valve, an exhaust valve, a balancer and the like are driven from a crankshaft of a four-cycle engine, is shown in FIG. 7. The mechanism comprises a valve on off timing transmission mechanism M1 including a valve driving crankshaft sprocket A11a, a camshaft sprocket A12a for intake valves, a camshaft sprocket A12b for exhaust valves, a valve on off timing silent chain 20a looped over the three sprockets, a tensioner 30a, which provides tension in the chain 20a, and a balancer transmission mechanism M2, including a balancer driving crankshaft sprocket A11b the shaft of which is coaxially supported with the valve driving crankshaft sprocket A11a, a balancer shaft sprocket A13, a balancer driving silent chain 20b looped over sprockets A11a and A13 and a tensioner 30b, which provides tension in chain 20b. Although only one balancer shaft sprocket is shown, in a typical four-cycle engine, two balancer shafts, each having its own sprocket, are provided, each driven through a balancer chain from a separate balancer driving crankshaft sprocket.

In both chains 20a and 20b, link rows, each composed of a plurality of link plates, are connected by connecting pins, with the link plates of successive rows interleaved with one another. Each link plate has a pair of punched engaging teeth. The link plates of each link row are disposed in parallel to one another in the chain width direction and combined at random.

When the valve driving crankshaft sprocket A11a rotates twice, the intake valve and exhaust valve are each rotated once. Thus, the rotational speed of the crankshaft side must be reduced by ½ at the camshaft, and, accordingly the numbers of teeth on the intake valve camshaft sprocket A12a and the exhaust valve camshaft sprocket A12b are each twice the number of teeth on the valve driving crankshaft sprocket A11a.

When the balancer driving crankshaft rotates once, the balancer shaft is rotated twice, to compensate for a high degree of unbalance in the crankshaft. Thus, the rotational speed of the balancer driving crankshaft side must be doubled at the balancer shaft, and the number of teeth on the balancer driving crankshaft sprocket A11b is twice the number of teeth on the balancer shaft sprocket A13.

Involute teeth obtained under the same tooth cutting conditions, that is involute teeth cut with a hob cutter HC having the same hob pitch Ph as the chain pitch Pc of the above-mentioned silent chain, are formed on the valve driving crankshaft sprocket A11a, the camshaft sprockets A12a and A12b, and the balancer shaft sprocket A13.

As shown in FIG. 8A, even though the link plates 21 of the valve on off chain 20a and the balancer chain 20b are punched accurately, slight shifts in the positions of the drilled pin holes 21a are generated in drilling positions of the pin holes 21a due to punching vibration during the punching operation. Accordingly the distances A and B, from the peripheries of the holes to the outer tooth flanks can differ, and the distances C and D, from the centers of the holes to a midpoint along the length of the link plate, can also differ. Thus, the link plates 21 are not always symmetrical left and right, as shown in FIG. 8C, where A=B and C=D. Rather, a typical link plate is characterized by the conditions A>B, and C<D, as shown in FIG. 8A.

In FIGS. 8A, 8B and 8C, “w” is the width of the link plate in the longitudinal direction of the chain, and “h” is the height measured from the chain pitch line to the intersection of imaginary extensions of straight portions of the outer flanks of the link plate. As shown in FIG. 8B, during assembly of the chain, when large numbers of link plates 21 are combined in parallel in the chain width direction at random to form link rows 22, the shapes, W and H, of the link rows 22, which correspond to envelopes of the dimensions w and h of the individual link plates 21, are liable to become slightly larger than the outer dimensions (w, h) of the individual link plates 21. Even if all the link plates were punched so that they are identical, if dimensions A and B differ slightly, or dimensions C and D differ slightly, reversal of a given link plate in the front-to-back direction in assembly of a link row will result in the condition depicted in FIG. 8B.

Accordingly, engagement failures will occur, even in the case of a sprocket formed for optimum engagement conditions by a hob cutter HC having a hob pitch Ph which is the same as the chain pitch Pc, measured between a pair of pin holes punched in the link plates. These engagement failures are due to tight engagement between the sprocket and the link plates because of the differences δw and δh (shown in FIGS. 8B and 8C, respectively) between the outer dimensions W and H of the link row 22, and the outer dimensions w and h of the individual link plates 21. These differences lead to the generation of noise and vibration in the silent chain. The problems of noise and vibration could not be solved easily by controlling only the shape and structure of the silent chain.

Referring again to FIG. 7, in a conventional silent chain transmission mechanism, all involute teeth of the valve driving crankshaft sprocket A11a, the camshaft sprocket A12, and the balancer shaft sprocket A13, all of which have different numbers of teeth, are produced using a hob cutter HC having a hob pitch Ph. Thus, it is very difficult to attain optimum engagement between a chain and all of these different sprockets, and it is not possible to avoid engagement failure, which can occur at any sprocket. Engagement failure leads to a further increase in noise and vibration.

In particular, the camshaft sprocket A12 has a large number of teeth, and the number of link plates wrapped around the camshaft sprocket is larger than the number of link plates wrapped around the valve driving crankshaft sprocket A11a, which has a smaller number of teeth. The balancer driving-crankshaft sprocket A11b has a larger take-up angle than the balancer shaft sprocket A13. Therefore, on the camshaft sprockets, and on the balancer driving crankshaft sprocket, the cumulative effect of the above-mentioned tight engagement causes the silent chain to travel outside the original chain pitch line L and there were problems that the traveling line departed from an allowable range in the layout design on the chain pitch line, with an adverse effect on properties of the transmission mechanism, including its noise, vibration, and friction properties, and its traveling stability.

### SUMMARY OF THE INVENTION

Accordingly, an object of this invention is to provide a silent chain transmission mechanism, in which the link rows of a silent chain are composed of parallel link plates combined at random, and the link rows are interleaved with one another and connected by connecting pins, which can travel properly, without dislodging, on a layout-designed chain pitch line, and in which improved noise, vibration, and friction properties, and improved traveling stability, can be realized.

The silent chain transmission mechanism in accordance with the invention comprises a silent chain composed of link rows connected to one another by connecting pins, and a sprocket. Each link row of the chain consists of toothed link plates selected at random and arranged in parallel, side-by-side, relationship to one another. The link plates of each link row are interleaved with link plates of two adjacent link rows. The sprocket is in mesh with the chain and its teeth are cut with a hob cutter having a hob pitch smaller than the chain pitch of the silent chain.

In a preferred embodiment, the ratio of the hob pitch to the chain pitch of said silent chain is within a range from 0.96 to 1.00.

The term “chain pitch,” when used with reference to the silent chain in this invention, means the central space between a pair of pin holes punched in the link plate, or a central space between a pair of connecting pins inserted through the link plate. The term “hob pitch,” when used with reference to a hob cutter, means the spacing between corresponding points on successive rack teeth in a section perpendicular to the tooth line of the hob cutter.

Further, in a silent chain transmission mechanism, when the ratio of the hob pitch to the chain pitch of the silent chain is within a range from 0.96 to 1.00, optimum engagement of the chain with a sprocket, with low noise and low vibration, can be realized. However, when the pitch ratio is less than 0.96, failure due to jumping of the sprocket teeth occurs, and noise and vibration cannot be reduced. Moreover, when the pitch ratio exceeds 1.00, the engagement becomes tight, engagement failure is liable to occur, and noise and vibration cannot be reduced.

The silent chain transmission mechanism of the invention transmits power between sprockets having different numbers of teeth, and the predominant characteristic actions and effects of the silent chain transmission mechanism are as follows.

The sprocket produced using a hob cutter having a hob pitch which is smaller than the chain pitch, has slightly thinner individual sprocket teeth. The number of teeth on the sprocket is not affected, but the diameter of the sprocket becomes slightly smaller compared with the diameter of a sprocket produced by a hob cutter having a hob pitch which is the same as the chain pitch.

Therefore, in the case of a silent chain composed of link plates combined at random in such a way that the envelope shape of a link row is larger than the outer shape of an individual link plate, the link rows can be accommodated in the respective spaces between the thinner teeth of the sprocket. Accordingly, the silent chain can travel correctly on a layout-designed chain pitch line, and engage reliably with the sprockets of the transmission mechanism.

In the cases of a sprocket having a large number of teeth and a large number of taken-up link plates, and a sprocket having a take-up angle of 180 degrees or more, the respective spaces between the thinner teeth of the sprockets can accommodate the outer envelope shapes of successive link rows, where the outer envelope shapes are larger than the outer shapes of individual link plates. Thus, the invention can avoid the disadvantage of a silent chain traveling outside the original chain pitch line due to excessive cumulative tight engagement, as in the conventional case.

In addition to the above effects, the silent chain transmission mechanism can ensure optimum engagement height during the engagement of the silent chain with the sprockets, when the pitch ratio of the hob pitch to the chain pitch of said silent chain is within a range of from 0.96 to 1.00. Link rows mutually connected together, pivot smoothly, and articulate about their connecting pins, so that engagement failure and jumping of the sprocket teeth do not occur.

### BRIEF DESCRIPTION OF THE DRAWINGS

A preferred embodiment of the invention will now be described in detail, by way of example only, with reference to the accompanying drawings, in which:

FIG. 1A is a schematic elevational view illustrating the tooth cutting of a sprocket in accordance with a conventional tooth cutting operation, and comparing it with the tooth cutting operation of the invention, shown in phantom view; FIG. 1B is a schematic elevational view illustrating the tooth cutting of a sprocket in accordance with the invention, the conventional tooth cutting operation being shown in phantom view;

FIG. 2A is a schematic elevational view illustrating the engagement of a chain with a sprocket in a transmission of the prior art; FIG. 2B is a schematic elevational view illustrating the engagement of a chain with a sprocket in a transmission of the invention.

FIG. 3 is a graph showing the relationship between the noise level and the ratio of the sprocket tooth cutting hob pitch to chain pitch.

FIG. 4 is a schematic view showing the engagement of a chain with a sprocket, and the relation ship between the chain pitch and the sprocket pitch, where the ratio of the hob pitch to the chain pitch of the silent chain is 1.00 or more;

FIG. 5 is a schematic view showing the engagement of a chain with a sprocket, and the relation ship between the chain pitch and the sprocket pitch, where the ratio of the hob pitch to the chain pitch of the silent chain is within the optimum range of from 0.96 to 1.00;

FIG. 6 is a schematic view showing the engagement of a chain with a sprocket, and the relation ship between the chain pitch and the sprocket pitch, where the ratio of the hob pitch to the chain pitch of the silent chain is less than 0.96;

FIG. 7 is a schematic elevational view of a silent chain transmission mechanism; and

FIGS. 8A, 8B, 8C are elevational views illustrating the difference between the outer shape of a link row and the outer shape of an individual link plate.

### DETAILED DESCRIPTION OF THE PREFERRED EMBODIMENT

A preferred embodiment of a silent chain transmission mechanism of the invention will be described with reference to the drawings.

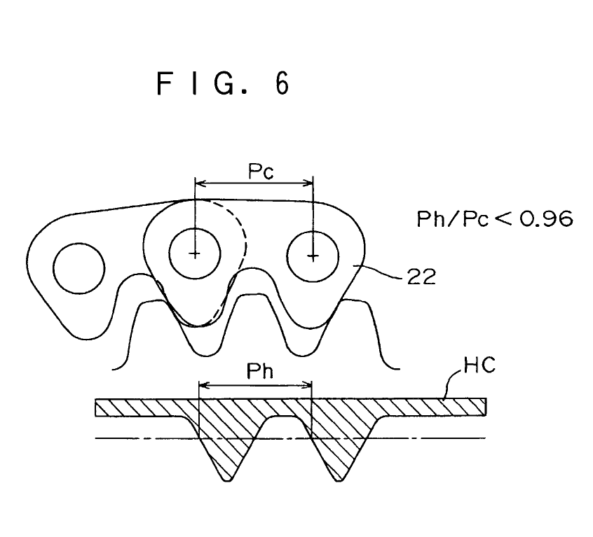

The silent chain transmission mechanism of the invention is generally the same as the silent chain transmission mechanism in a conventional four-cycle engine shown in FIG. 7, as described above.

Referring to FIG. 7, in the valve on off timing silent chain 20a and the balancer driving silent chain 20b, link rows 22 are interleaved with one another. Each link row comprises a plurality of link plates 21, each having a pair of engaging teeth punched from a blank steel sheet. The link plates in each row are arranged in parallel and combined at random. The chains 20a and 20b have the same shapes and structures, differing from each other only in that they have different numbers of connected link rows 22.

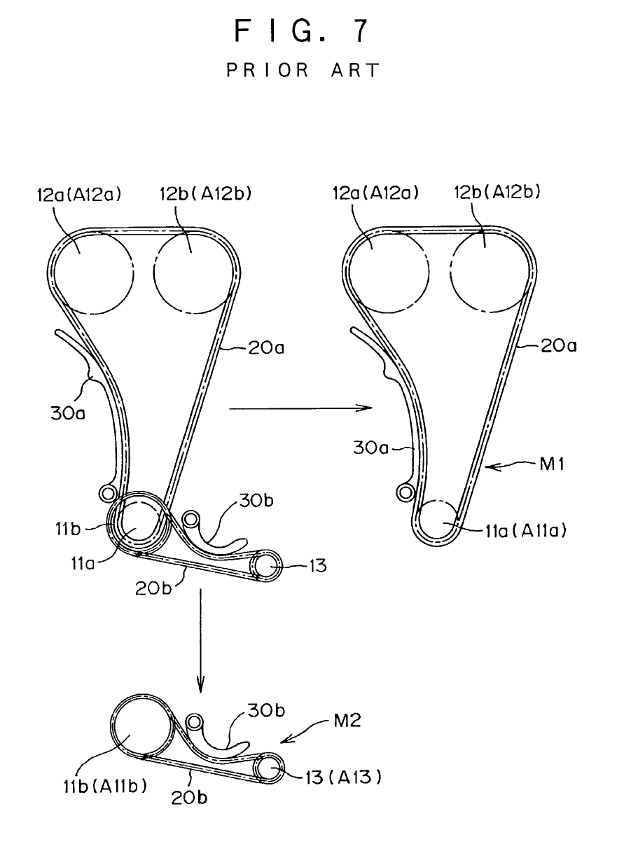

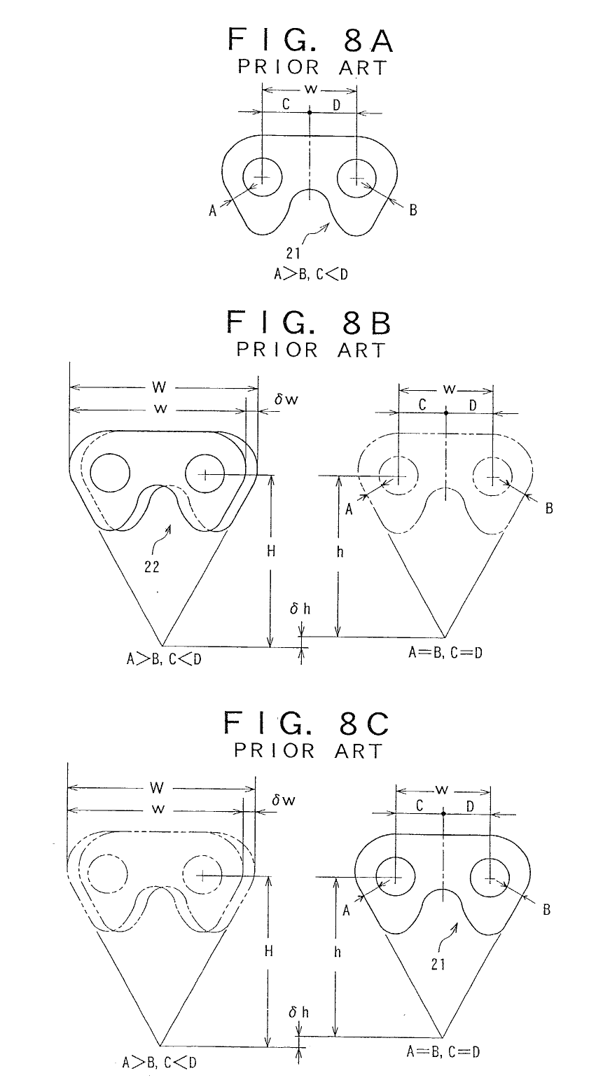

As mentioned previously, the individual link plate 21 exhibit slight differences in the distances between the perimeters of the pin holes and the outer flanks, and from the centers of the respective pin holes to an axis of symmetry, as shown in FIG. 8A. These differences (A>B, C<D) result from vibration during the punching operation, even when every effort is made to carry out the punching operation with high accuracy. Thus, the positions of the pin holes are not always symmetrical (A=B, C=D) as shown in FIG. 8C.

Therefore, when link plates 21 are selected at random and arranged in parallel to produce a link row 22, the chain pitch Pc, which corresponds to the center-to-center distance of the pin holes in a link plate is predetermined. However, as shown in FIG. 8B, the outer shape (W, H) of a link rows 22, which corresponds to an envelope of the outer shapes (w, h) of the individual link plates in the link row is slightly larger than the outer shape (w, h) of the individual link plates 21.

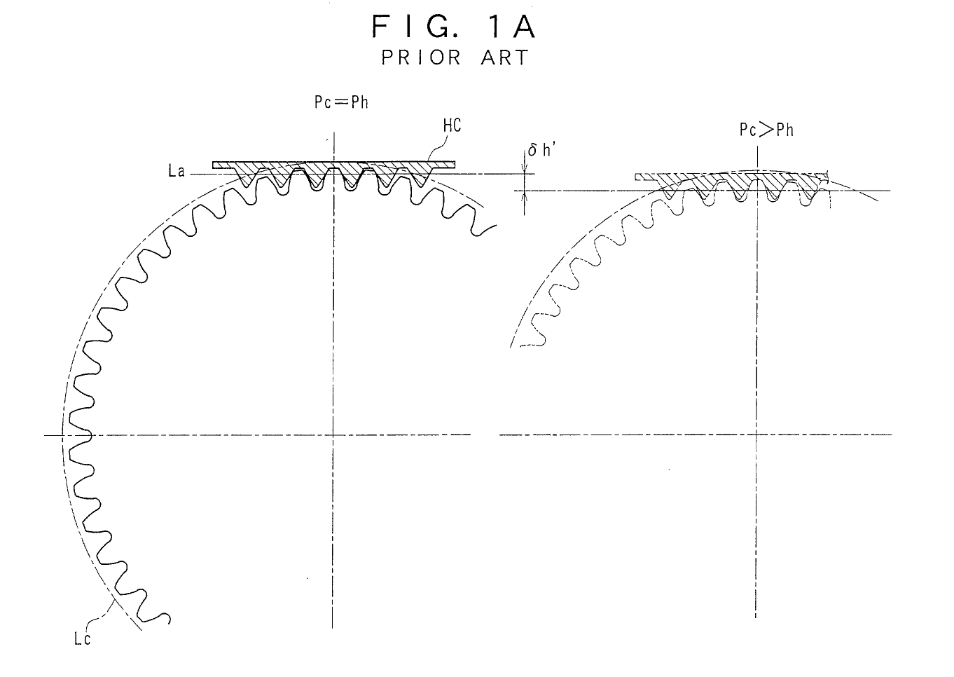

As shown in FIG. 1B, the involute teeth of the crankshaft sprocket 11a, the camshaft sprockets 12a and 12b, and the balancer shaft sprocket 13, are formed by a hob cutter HC under cutting conditions such that the hob pitch Ph is smaller than the chain pitch Pc. The sprocket has the same number of teeth as a sprocket in which the teeth are cut so that the hob pitch Ph is equal to the chain pitch Pc. However, the individual sprocket teeth have a slightly thinner involute tooth shape, and the diameter of the sprocket is smaller. The distance δh′ in FIG. 1B is the difference in the feed of the hob cutter HC in a conventional cutting operation and the cutting operation in accordance with the invention. δh′ is approximately the difference which can accommodate the difference δh, shown in FIGS. 8B and 8C, between the height h in an individual link plate, and the height H of a link row. Line La in FIGS. 1A and 1B is the engagement pitch line.

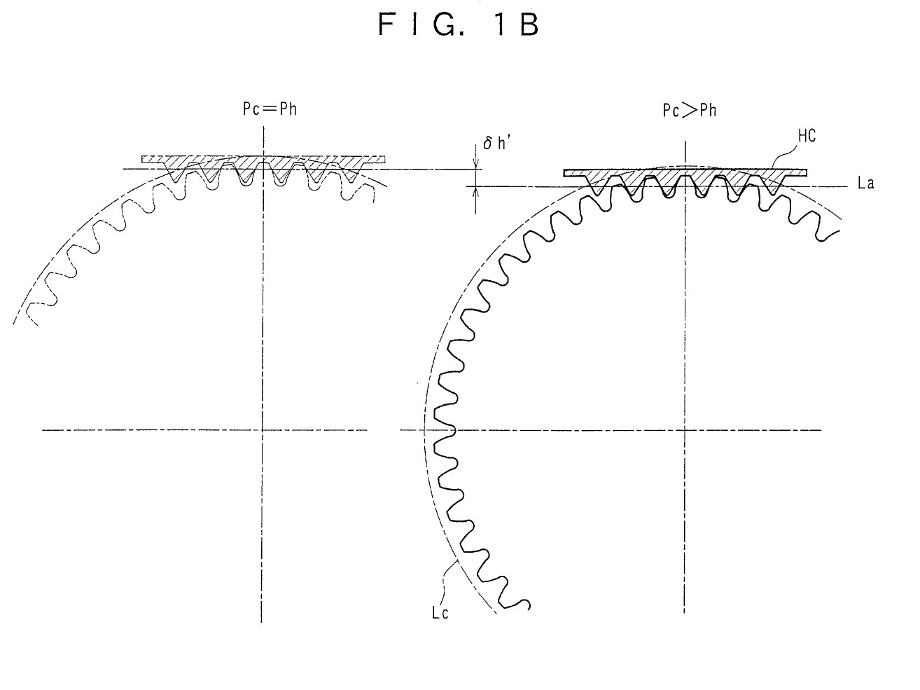

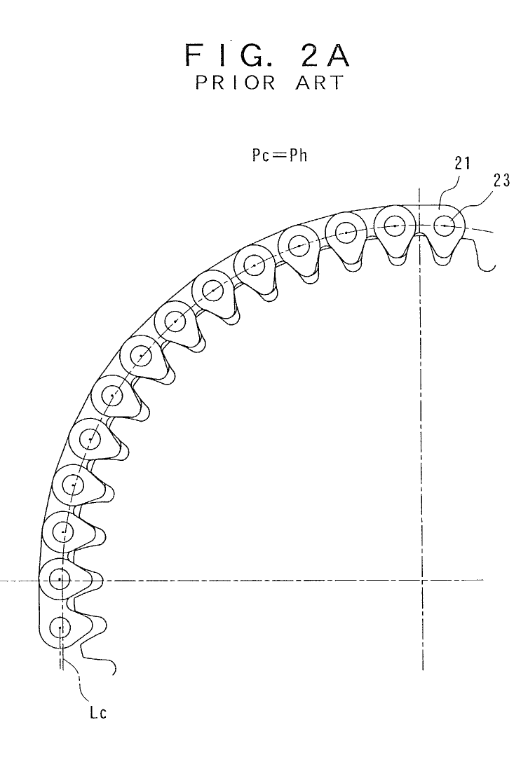

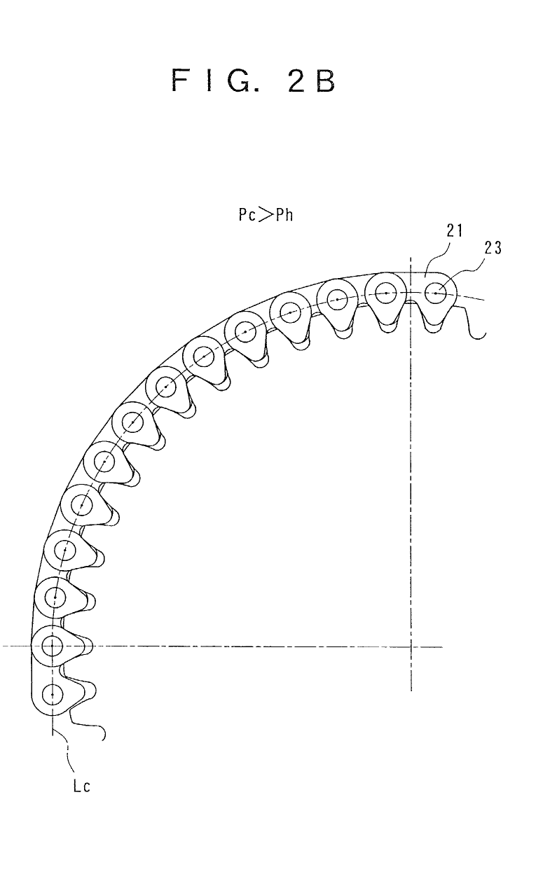

The basic operation of the silent chain transmission mechanism of the invention will be described with reference to FIGS. 2A and 2B.

The differences (w and h) between the outer shapes (W and H) of a link row 22, and the outer shapes (w and h) of the individual link plates 21 are accommodated by the sprocket produced in accordance with the invention by a hob cutter HC having a hob pitch smaller than the chain pitch. Thus, the valve on off timing silent chain 20a and the balancer driving silent chain 20b travel correctly on a layout-designed chain pitch line and correctly and reliably engage the crankshaft sprocket 11a, the camshaft sprockets 12a and 12b and, the balancer shaft sprocket 13.

Each of the camshaft sprockets 12a and 12b has a large number of teeth, and a large number of links of the chain engaged with it. Likewise, the balancer driving crankshaft sprocket 11b (FIG. 7) has a large take-up angle. Even in the cases of the camshaft sprocket and the balancer driving crankshaft sprocket, the added dimensions (w, h) of the outer shapes (W and H) of the link rows 22, which are larger than the outer shapes (w and h) of the individual link plates 21, can be sequentially accommodated in the spaces between the thin sprocket teeth. Therefore, as shown in FIG. 2B, the valve on off timing silent chain 20a and the balancer driving silent chain 20b do not travel outside the original chain pitch line Lc due to excessive accumulated tight engagement as in the conventional case depicted in FIG. 2A.

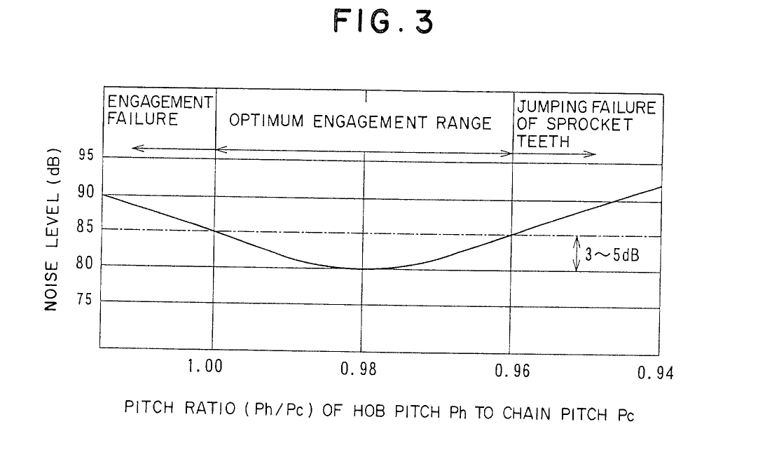

The noise level and engagement of the silent chain transmission mechanism in accordance with the invention will now be described with reference to FIGS. 3 to 6.

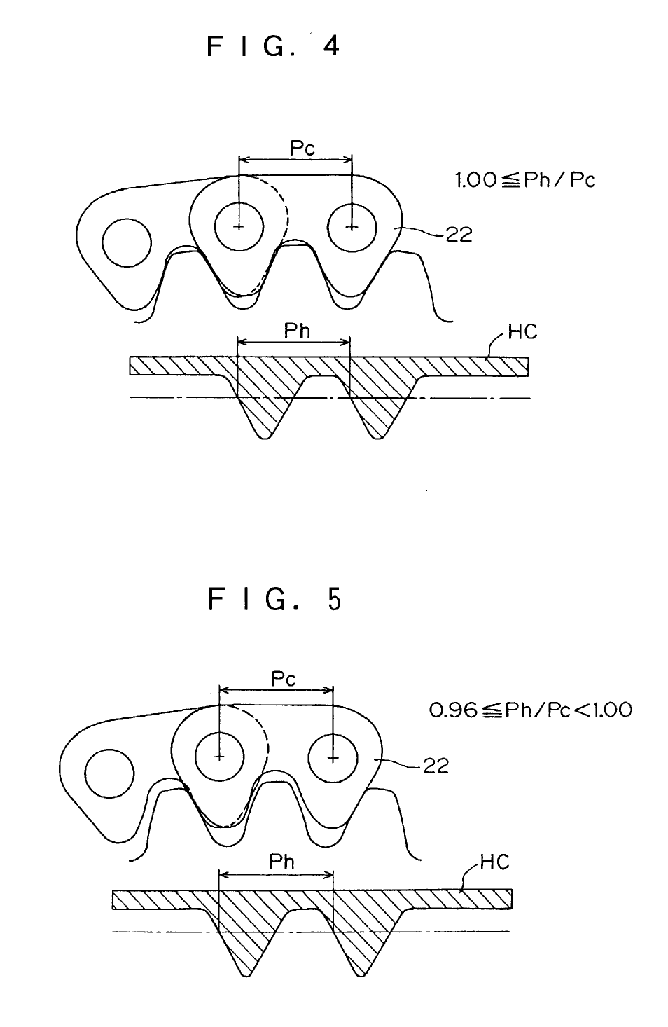

As shown in FIG. 4, in a silent chain transmission mechanism in which the pitch ratio (Ph/Pc) of the hob pitch Ph to the chain pitch Pc is 1.00 or more, the silent chain travels on the outside the layout-designed chain pitch line due to tight engagement of the silent chain with the sprockets. Accordingly, where Ph/Pc is 1.00 or more, optimum engagement height cannot be ensured, engagement failure may occur, and the noise and vibration cannot be reduced.

As shown in FIG. 5, in a silent chain transmission mechanism in accordance with the invention, in which the pitch ratio (Ph/Pc) of the hob pitch Ph to the chain pitch Pc is in the range of from 0.96 to 1.00 but less than 1.00, the optimum engagement height can be ensured during the engagement between the silent chain with the sprockets. Accordingly, the interconnected link rows 22, while in engagement with the sprocket teeth, can articulate, rotating smoothly about their connecting pins so that no engagement failure or jumping of the sprocket teeth occurs.

As shown in FIG. 6, in a silent chain transmission mechanism in which the pitch ratio (Ph/Pc) of the hob pitch Ph to the chain pitch Pc is less than 0.96, the silent chain travels on the outside of the layout-designed chain pitch line during engagement of the chain with the sprockets. Noise and vibration cannot be reduced and jumping of the sprocket teeth occurs.

Unlike a conventional silent chain, in the transmission mechanism in accordance with the invention, the silent chain can travel correctly on the sprocket, without departing from the layout-designed chain pitch line Lc. Remarkable noise, vibration and friction properties, and traveling stability can be achieved.

An exemplary silent chain transmission mechanism has been described in the context of a valve on off timing transmission mechanism M1 and a balancer transmission mechanism M2 including a balancer driving crankshaft sprocket 11b, and balancer shaft sprockets, the former (M1) effecting a speed reduction, and the latter (M2) effecting a speed increase. However, same beneficial effects can be attained where the invention utilized in other silent chain transmission mechanisms, for example a mechanism for driving an auxiliary device such an oil pump or the like.

The silent chain transmission mechanism according to the invention transmits power between sprockets having different numbers of teeth and has the following specific effects. First, by cutting the teeth of a sprocket with a hob cutter having a hob pitch smaller than the chain pitch of the silent chain, the sprocket is able to receive the link rows of the chain reliably and smoothly even though the outer shapes the link rows are larger than the outer shape of an individual link plates. Accordingly, the silent chain travels correctly on a layout-designed chain pitch line, and engagement of the silent chain with the sprocket with low noise and low vibration can be realized. In assembly of the chain link plates can be easily combined in parallel to produce a link row, without checking whether to determine whether or not each link plate is reversed in the front to back direction. Accordingly production of the chain is significantly improved.

Even a sprocket having a large number of teeth and larger number of links engaged with it, and a sprocket having a large take-up angle, reliably and smoothly mesh sequentially with link rows having outer shapes larger than the outer shapes of their individual link plates. Therefore, the silent chain does not travel outside the original designed chain pitch line due to excessive accumulation of tight engagement as in the case of a conventional silent chain transmission. Improved engagement of the silent chain with the sprocket can be attained.

Optimum engagement height during the engagement of the silent chain with a sprocket can be ensured by forming the sprocket with a hob cutter having a hob pitch such that the ratio of the hob pitch to the chain pitch is within a range from 0.96 to 1.00, but less than 1.00. Thus, according to the invention, link rows mutually interconnected to form a chain articulate smoothly, pivoting about their connecting pins, so that the engagement failure and jumping of the sprocket teeth do not occur, and optimum engagement of the silent chain with the sprocket can be realized.

Various minor changes and modifications of the invention are possible in the light of the above teaching. It is therefore to be understood that within the scope of the appended claims, the invention may be practiced otherwise than as specifically described.

What is claimed is:

1. A silent chain transmission mechanism comprising a silent chain composed of link rows connected to one another by connecting pins, each link row consisting of toothed link plates selected at random and arranged in parallel, side-by-side, relationship to one another, the link plates of each link row being interleaved with link plates of two adjacent link rows, and a sprocket in mesh with said chain, the sprocket having teeth cut with a hob cutter having a hob pitch smaller than the chain pitch of said silent chain.

2. The silent chain transmission mechanism according to claim 1, wherein the ratio of the hob pitch to the chain pitch of said silent chain is within a range from 0.96 to 1.00.
